(19) United States
(12) Patent Application Publication
(10) Pub. No.: US 2015/0179302 A1
(43) Pub. Date: Jun. 25, 2015

(54) WATER RESISTANT STRUCTURE FOR FLEXIBLE CIRCUIT CABLE

(71) Applicant: ADVANCED FLEXIBLE CIRCUITS CO., LTD., Taoyuan County (TW)

(72) Inventors: GWUN-JIN LIN, Taoyuan County (TW); KUO-FU SU, Taoyuan County (TW)

(21) Appl. No.: 14/506,826

(22) Filed: Oct. 6, 2014

(30) Foreign Application Priority Data
Dec. 25, 2013 (TW) 102148171

(51) Int. Cl. H01B 7/282; H01B 7/06

(52) U.S. Cl. CPC H01B 7/282; H01B 7/06

(57) ABSTRACT

A water resistant structure for a flexible circuit cable is disclosed. The flexible circuit cable has a first surface, a second surface, a first end, a second end, and an extension section connecting between the first end and the second end. The extension section of the flexible circuit cable extends in an extension direction and defines a water resistant section. The water resistant section has a predetermined water resistant section length. The water resistant section of the flexible circuit cable includes at least one pad member and a water resistant material formed thereon. The water resistant material and the pad member provide the flexible circuit cable with an effect of water resistance.

### BACKGROUND OF THE INVENTION

1. Field of the Invention

The present invention relates to a water resistant structure for a flexible circuit cable, and in particular to a water resistant structure for a flexible circuit cable that comprises at least a pad member formed on a water resistant section of the flexible circuit cable and a water resistant material enveloping the pad member and the water resistant section of the flexible circuit cable.

2. The Related Arts

A flexible flat cable has been widely used in various electronic devices, such as notebook computers, personal digital assistants, and mobile phones. Structurally, a conventional flexible flat cable comprises a plurality of conductor wires that is each covered by an insulation layer and is arranged side by side to form a flat cable and is used in combination with a connector and circuit soldering for transmission of electronic signals.

There is no particular concern about the issue of water resistance when the flexible flat cable is used to connect electronic devices. However, for outdoor applications or for use with portable electronic devices (such as mobile phones), water resistance or humidity resistance is surely an issue to be taken care of. For example. in the field of applications of mobile phones, a flexible flat cable is used to connect a host device and a display screen of a mobile phone by means of connectors or soldering. In case that poor water resistance exists between the flexible flat cable and the host or screen of the mobile phone, water may flow along the flexible flat cable into the interior of the host or the screen of the mobile phone.

To achieve the purpose of water resistance or humidity resistance, in known designs, the most commonly used solution is arranging a rubber pad as a water resistant material that is interposed between a casing of an electronic device and a flat cable so that water resistance or humidity resistance is achieved with tight engagement between the water resistant material and the casing and the flat cable of the electronic device.

Recently developed techniques allow for directly mounting a water resistant material on an insulation surface material of a flat cable, which is effective in achieving a desired purpose of primary water resistance or humidity resistance. However, there are still concerns regarding reliability between the water resistant material and the flat cable. For example, a portable electronic device is often operated very frequently and this leads to issues concerning positional shifting and gapping between the water resistant material and the flat cable resulting from frequent flexing of the water resistant material mounted to the flexible circuit flat cable. Such gapping allows moisture of water or humidity to flow along a circuit cable into the interior of the portable electronic device and eventually, damages of the portable electronic device may result.

The primary cause is that the water resistant material is hard to tightly couple to the insulation material (such as PI and insulative ink) on the surface of a flat cable. Although treatments can be made with known surface treatment agents, the effect of water resistance and adherence is still not good enough so that the mechanical adherence between the water resistant material and flat cable is often inadvertently affected due to unexpected errors occurring in a manufacturing process, leading to problems concerning incapability of bearing water pressure, such as sliding, detachment, and water leakage between the water resistant material and the flat cable. Thus, it is a challenge of the manufacturers of the field to provide a solution for overcoming the above-discussed technical insufficiency.

### SUMMARY OF THE INVENTION

Thus, to overcome the above problems, an object of the present invention is to provide a water resistant structure for a flexible circuit cable, which comprises a flexible circuit cable having a first surface, a second surface, a first end, a second end, and an extension section connecting between the first end and the second end. The extension section of the flexible circuit cable extends in an extension direction and defines a water resistant section. The water resistant section has a predetermined water resistant section length.

The flexible circuit cable comprises a flexible substrate, a first metal layer, a first insulation layer, and a second metal layer. The metal layer of the flexible substrate comprises the first insulation layer formed thereon. At least one pad member and a water resistant material are arranged on the water resistant section of the flexible circuit cable. The pad member is bonded to the water resistant material so as to provide excellent water resistance and mechanical adherence between the water resistant material and a flat cable.

In a preferred embodiment, the circuit cable can be a single-sided printed circuit board, a double-sided printed circuit board, or a multiple-layer printed circuit board, or a flexible circuit board, or a rigid-flex circuit board. For example, the flexible circuit cable comprises a flexible substrate, a first metal layer, a first insulation layer, a second metal layer, and a second insulation layer. The water resistant section of the flexible circuit cable comprises at least one pad member and a water resistant material arranged thereon. The pad member has a pad member length in an extension direction that is greater than a water resistant section length and an exposed section is formed at one side of the pad member. The exposed section extends on the flexible circuit cable. The first surface of the flexible circuit cable further comprises an outer cover section formed thereon. With the arrangement that the pad member length is greater than the water resistant section length, bonding between the water resistant material and the flexible circuit cable is made tighter without causing any undesired detachment and shifting.

The water resistant material can be made of a material selected from one of silicone rubber, rubber, silica gel, and resin that contains conductive particles. In different applications, the selection of such materials provides effects of electrical conduction and magnetic protection. The pad member is mounted to the water resistant section of the flexible circuit cable. The pad member can be made of a material selected from one of a metal material and an insulation material. The pad member can be structured to comprise at least one indentation formed on the pad member and not extending through the pad member or at least one through hole formed in and extending through the pad member. The pad member may have a surface that comprises a roughened surface structure to improve the adherence between the pad member and the water resistant material so as to make the bonding between the water resistant material and the flexible circuit cable tighter without causing undesired detachment and shifting. The pad member may have a surface that is coated with a surface treatment agent also to improve the adherence between the surface of the pad member and the water resistant material.

As to the efficacies. the present invention comprises a flexible circuit cable that has a predetermined water resistant section on which a pad member is provided. The pad member is bonded to the water resistant material so that the flexible circuit cable has excellent water resistance on a first surface and a second surface thereof and eliminate gapping formed between the water resistant material and the flat cable resulting from frequent twisting. The pad member prevents moisture of water or humidity from flowing along the flexible circuit cable in the interior of a portable electronic device to achieve an effect of water resistance. Further, in a practical application, bonding the pad member to the flexible circuit cable can be achieved with a simple manufacturing process thereby showing an excellent value of industrial utilization.

### BRIEF DESCRIPTION OF THE DRAWINGS

The present invention will be apparent to those skilled in the art by reading the following description of preferred embodiments of the present invention, with reference to the attached drawings, in which:

FIG. 1 is a perspective view showing a water resistant structure for a flexible circuit cable according to a first embodiment of the present invention;

FIG. 2 is an exploded view showing the water resistant structure according to the first embodiment of the present invention;

FIG. 3 is across-sectional view taken along line 3-3 of FIG. 1;

FIG. 4 is a cross-sectional view showing a second embodiment according to the present invention;

FIG. 5 is a cross-sectional view showing a third embodiment according to the present invention;

FIG. 6 is a cross-sectional view showing a fourth embodiment according to the present invention;

FIG. 7 is a cross-sectional view showing a fifth embodiment according to the present invention;

FIG. 8 is a cross-sectional view showing a sixth embodiment according to the present invention;

FIG. 9 is a cross-sectional view showing a seventh embodiment according to the present invention;

FIG. 10 is a cross-sectional view showing an eighth embodiment according to the present invention; and

FIG. 11 is a cross-sectional view showing a ninth embodiment of the present invention.

### DETAILED DESCRIPTION OF THE PREFERRED EMBODIMENTS

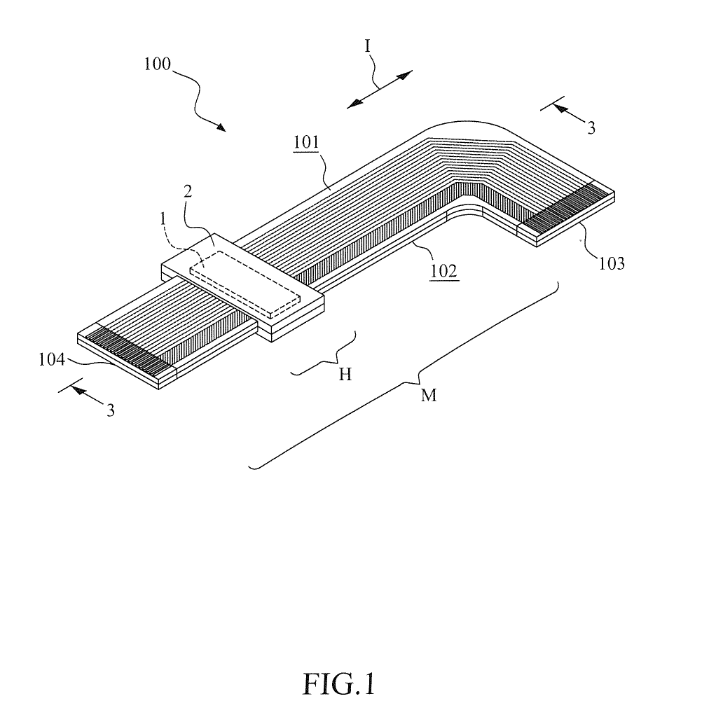

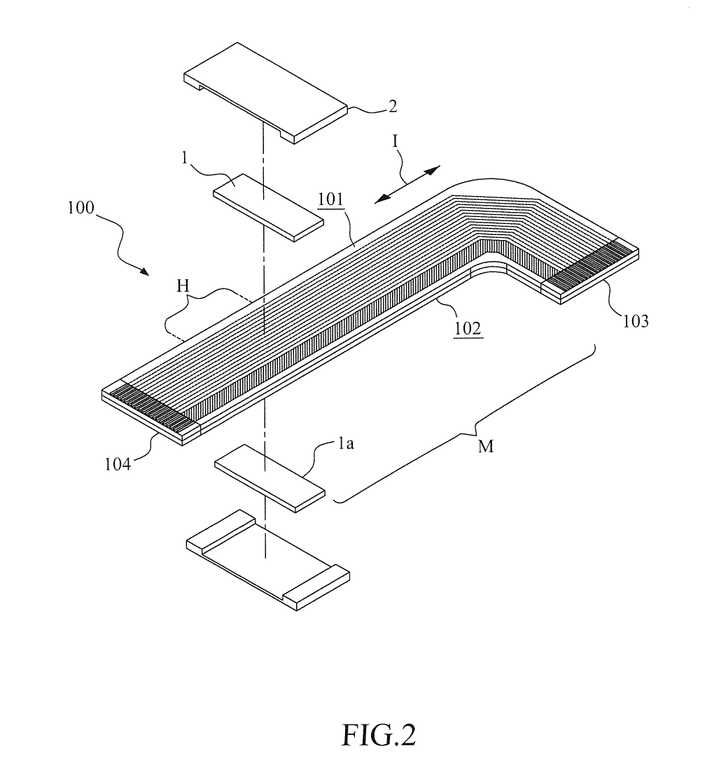

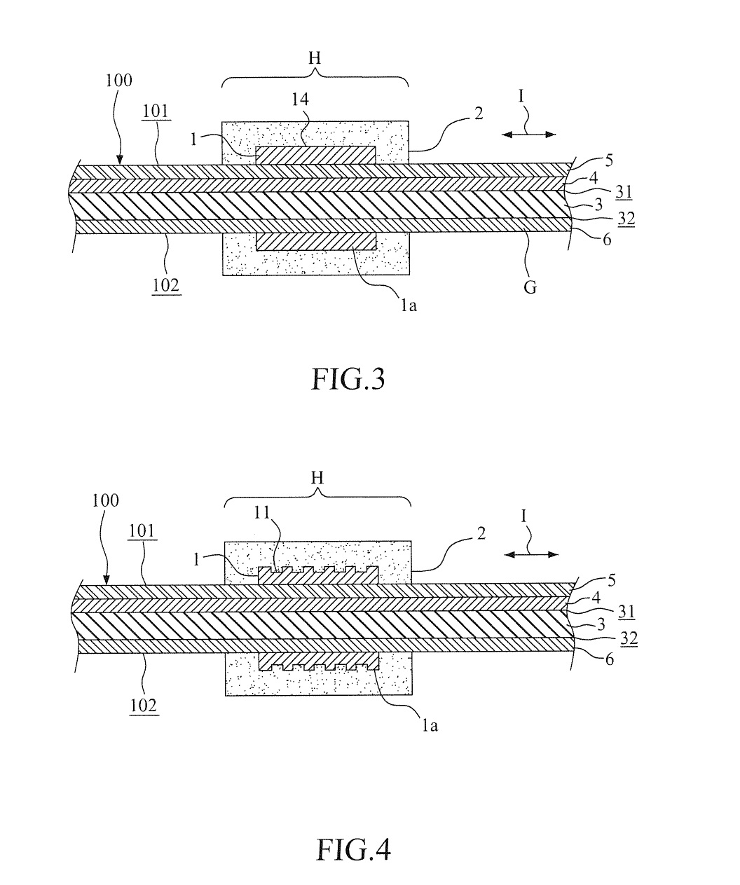

With reference to the drawings and in particular to FIG. 1, which is a perspective view showing a water resistant structure for a flexible circuit cable according to a first embodiment of the present invention, FIG. 2, which is an exploded view showing the water resistant structure according to the first embodiment of the present invention, and FIG. 3, which is a cross-sectional view taken along line 3-3 of FIG. 1. As shown in the drawings, a flexible circuit cable 100 has a first surface 101, a second surface 102, a first end 103, a second end 104 and an extension section M connecting between the first end 103 and the second end 104. The extension section M of the flexible circuit cable 100 extends in an extension direction I and defines a water resistant section H. The water resistant section H has a predetermined water resistant section length. The water resistant section H comprises at least one pad member 1 and a water resistant material 2 arranged thereon. The flexible circuit cable 100 comprises a flexible substrate 3, a first metal layer 4, a first insulation layer 5, and a second metal layer 6. Two pad members 1, 1a are preferably provided in the instant embodiment and have a length in the extension direction I that is shorter than the water resistant section H.

The pad members 1, 1a are mounted to the extension section M of the flexible circuit cable 100 and are respectively arranged on the first surface 101 and the second surface 102. The pad members 1, 1a are each made of a material selected from one of a metal material and an insulation material. The water resistant material 2 is molded to envelope the water resistant section H and the pad members 1, 1a. The water resistant material 2 is made of a material that is selected from one of silicone rubber, rubber, silica gel, and resin that contains conductive particles, whereby effects of electrical conduction and magnetic protection can be achieved with the selection of these materials.

The surface of each of the pad members 1, 1a can be coated with a layer of a surface treatment agent 14 in order to enhance adhesion property between the surface of the pad member 1 and the water resistant material 2.

The flexible substrate 3 comprises a first substrate surface 31 and a second substrate surface 32. The first substrate surface 31 receives the first metal layer 4 to form thereon and the first metal layer 4 receives the first insulation layer 5 to form thereon in order to achieve the effects of insulation and magnetic protection. The second substrate surface 32 of the flexible substrate 3 receives the second metal layer 6 formed thereon and the second metal layer 6 may serve as a grounding layer G.

FIG. 4 is a schematic view showing a second embodiment of the present invention. In the instant embodiment, most of the components and parts are similar to those of the previous embodiment and identical references are used to designate the same components and parts for consistency. As shown in the drawing, two pad members 1, 1a are respectively arranged on a first surface 101 and a second surface 102 of a flexible circuit cable 100. The pad member 1 comprises at least one indentation 11 formed thereon and not extending through the pad member 1. The indentation 11 helps improve adhesion between the pad member 1 and the water resistant material 2. The indentation 11 of the pad member 1 allows for a tighter bonding between the water resistant material 2 and the flexible circuit cable 100 without causing any undesired detachment and shifting. The indentation 11 of the pad member 1 can be one of a circle, a rhombus, a rectangle, an ellipse, a triangle, and other geometric shapes. The other pad member 1a may have same indentation structure corresponding to the indentation 11 of the pad member 1.

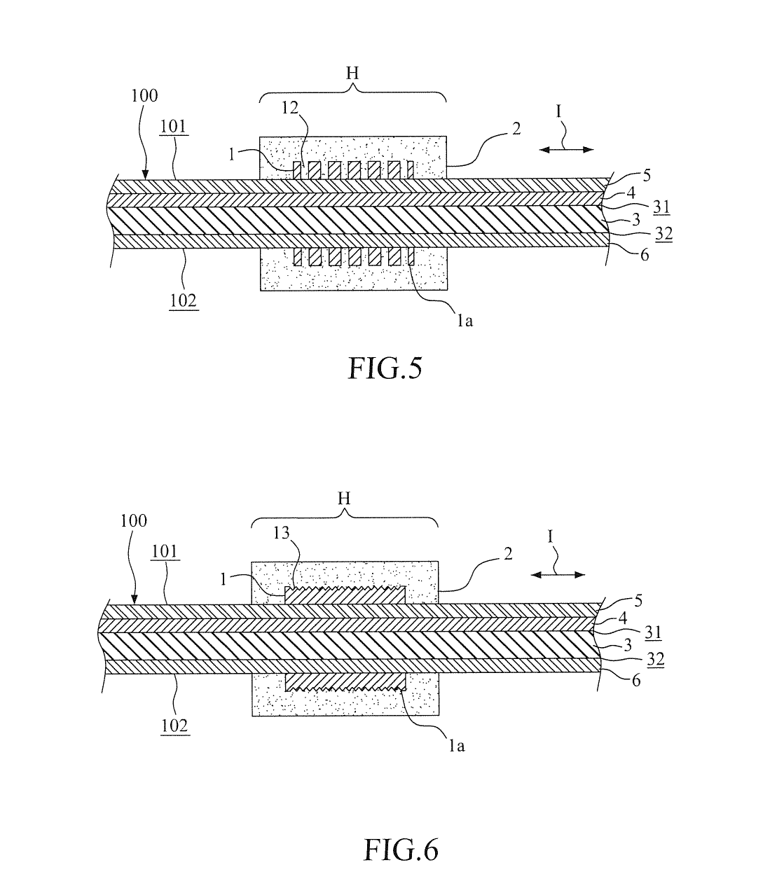

Referring to FIG. 5, which is a schematic view showing a third embodiment of the present invention. In the instant embodiment, most of the components and parts are similar to those of the second embodiment shown in FIG. 4 and identical references are used to designate the same components and parts for consistency. As shown in the drawing, the pad member 1 comprises at least one through hole 12 formed therein to extend through the pad member 1. The through hole 12 helps improve adhesion between the pad member 1 and the water resistant material 2. The through hole 12 of the pad members 1 allows for a tighter bonding between the water resistant material 2 and the flexible circuit cable 100 without causing any undesired detachment and shifting. The through hole 12 can be one of a circle, a rhombus, a rectangle, an ellipse, a triangle, and other geometric shapes.

Referring to FIG. 6, which is a schematic view showing a fourth embodiment of the present invention. In the instant embodiment, most of the components and parts are similar to those of the second embodiment shown in FIG. 4 and identical references are used to designate the same components and parts for consistency. As shown in the drawing, alternative to multiple indentations formed on the pad members 1, 1a, the surfaces of the pad member 1 may be provided with a roughened surface structure 13. The roughened surface structure 13 functions as a strengthening structure between the water resistant material 2 and the pad member 1. The roughened surface structure 13 helps improve the adherence between the pad member 1 and the water resistant material 2. The roughened surface structure 13 allows for a tighter bonding between the water resistant material 2 and the flexible circuit cable 100 without causing any undesired detachment and shifting.

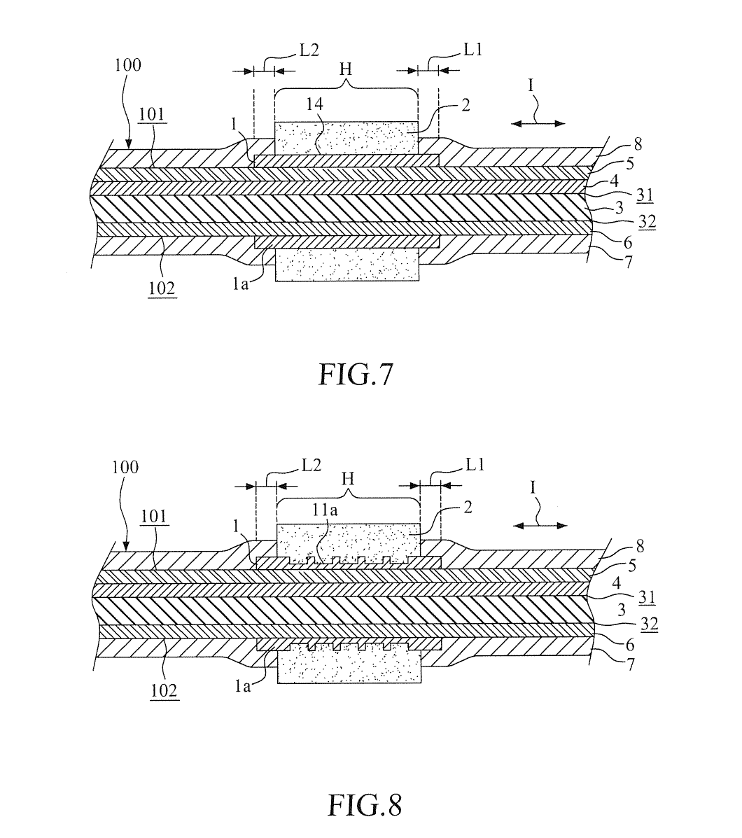

Referring to FIG. 7, which is a schematic view showing a fifth embodiment of the present invention, in the instant embodiment, most of the components and parts are similar to those of the previous embodiments and identical references are used to designate the same components and parts for consistency. In the instant embodiment. two pad members 1, 1a are respectively mounted on a first surface 101 and a second surface 102 at a water resistant section H of a flexible circuit cable 100. Further, a water resistant material 2 is molded to envelope the water resistant section H and the pad members 1, 1a. The flexible circuit cable 100 comprises a flexible substrate 3, a first metal layer 4, a first insulation layer 5, a second metal layer 6, and a second insulation layer 7. Each of the pad members 1, 1a has a length in an extension direction I that is greater than a length of the water resistant section H so that an exposed section L1, L2 extends from each side of the pad member 1, 1a and extends into and along a first surface 101 of the flexible circuit cable 100. The exposed sections L1, L2 of the pad member 1, 1a and the first surface 101 of the flexible circuit cable 100 further comprise an outer cover section 8 formed thereon. The second insulation layer 7 is formed on a surface of the second metal layer 6.

Referring to FIG. 8, which is a schematic view showing a sixth embodiment of the present invention, as shown in the drawing, the instant embodiment has a structure that is generally identical to that of the embodiment shown in FIG. 7 and a difference resides in that a surface of the pad member 1, 1a comprises at least one indentation 11a formed thereon but not extending through the pad member 1, 1a. The indentation 11a helps improve the adherence between the pad member 1, 1a and the water resistant material 2.

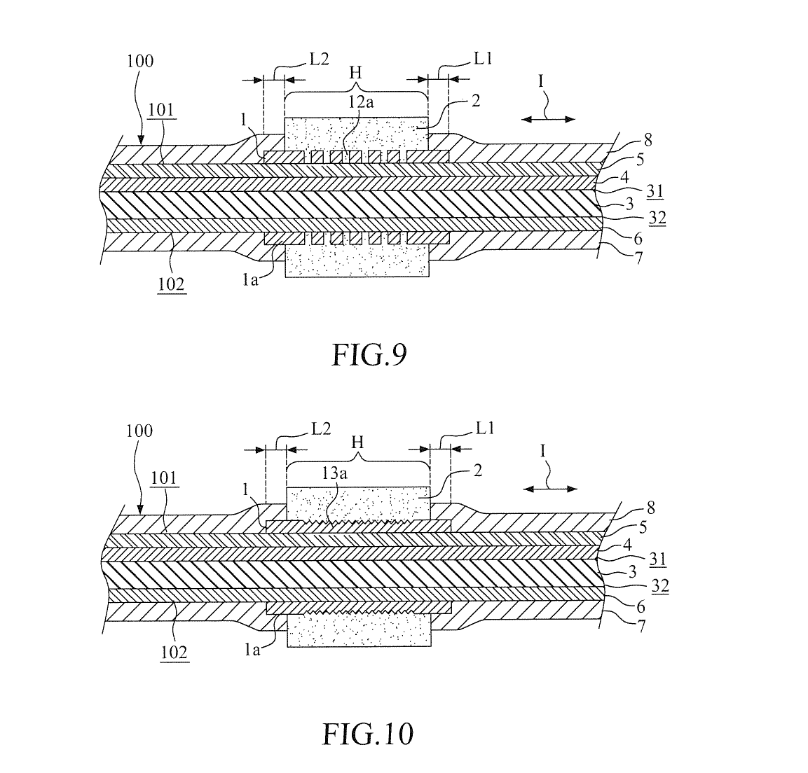

Referring to FIG. 9, which is a schematic view showing a seventh embodiment of the present invention, the instant embodiment has a structure that is generally identical to that of the embodiment shown in FIG. 7 and a difference resides in that the pad member 1, 1a comprises at least one through hole 12a formed therein and extending through the pad member 1, 1a. The through hole 12a helps improve the adherence between the pad member 1, 1a and the water resistant material 2. The through hole 12a of the pad member 1, 1a allows for a tighter bonding between the water resistant material 2 and the flexible circuit cable 100 without causing any undesired detachment and shifting.

Referring to FIG. 10, which is a schematic view showing an eighth embodiment of the present invention, compared to the embodiment shown in FIG. 7, a difference resides in that a pad member 1, 1a has a surface that comprises a roughened surface structure 13a and the pad member 1, 1a has a length that is greater than a length of the water resistant material 2. The roughened surface structure 13a of the pad member 1, 1a helps improve the adherence between the pad member 1, 1a and the water resistant material 2. The roughened surface structure 13a of the pad member 1, 1a allows for a tighter bonding between the water resistant material 2 and the flexible circuit cable 100 without causing any undesired detachment and shifting.

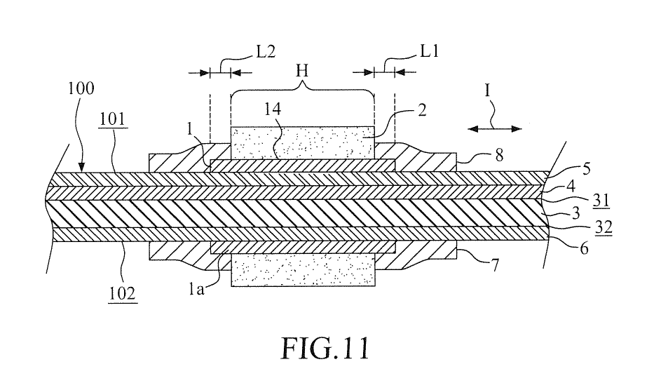

Referring to FIG. 11, which is a schematic view showing a ninth embodiment of the present invention, compared to the embodiment shown in FIG. 7, a difference resides in that an outer cover section 8 and a second insulation layer 7 do not completely cover the first surface 101 and the second surface 102 of the flexible circuit cable 100 and are formed only on exposed sections L1, L2 of the pad member 1, 1a and portions of the first surface 101 and the second surface 102.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A water resistant structure for a flexible circuit cable having a first surface, a second surface, a first end, a second end and an extension section connecting between the first end and the second end, the extension section of the flexible circuit cable extends in an extension direction and defining a water resistant section, the water resistant section having a predetermined water resistant section length, comprising:
at least one pad member mounted on the water resistant section of the extension section of the flexible circuit cable; and
a water resistant material enveloping the pad member and the water resistant section of the flexible circuit cable.

2. The water resistant structure as claimed in claim 1, wherein the pad member comprises at least one indentation formed thereon and not extending through the pad member.

3. The water resistant structure as claimed in claim 1, wherein the pad member comprises at least one through hole formed therein and extending through the pad member.

4. The water resistant structure as claimed in claim 1, wherein the pad member comprises a roughened surface structure formed thereon.

5. The water resistant structure as claimed in claim 1, wherein the pad member has a surface on which a surface treatment agent is coated.

6. The water resistant structure as claimed in claim 1, wherein the pad member is made of a material selected from one of a metal material and an insulation material.

7. The water resistant structure as claimed in claim 1, wherein the water resistant material is made of a material that is selected from one of silicone rubber, rubber, silica gel, and resin that contains conductive particles.

8. The water resistant structure as claimed in claim 1, wherein the water resistant material is made of a material that is selected from one of silicone rubber, rubber, and silica gel.

9. The water resistant structure as claimed in claim 1, wherein the pad member has a length in the extension direction that is shorter than the water resistant section length.

10. The water resistant structure as claimed in claim 1, wherein the pad member has a length in the extension direction that is greater than the water resistant section length, an exposed section being formed on at least one side of the pad member and extending into and along the first surface of the flexible circuit cable.

11. The water resistant structure as claimed in claim 10, wherein an outer cover section is formed on the exposed section of the pad member and the first surface of the flexible circuit cable.

12. The water resistant structure as claimed in claim 1, wherein the flexible circuit cable comprises:
a flexible substrate having a first substrate surface and a second substrate surface;
a first metal layer formed on the first substrate surface of the flexible substrate; and
a first insulation layer formed on the first metal layer.

13. The water resistant structure as claimed in claim 12, wherein the flexible circuit cable further comprises:
a second metal layer mounted to the second substrate surface of the flexible substrate; and
a second insulation layer formed on a surface of the second metal layer.

14. The water resistant structure as claimed in claim 13, wherein the second metal layer functions as a grounding layer for the flexible circuit cable.
